(19) United States
(12) Patent Application Publication
(10) Pub. No.: US 2025/0155305 A1
(43) Pub. Date: May 15, 2025

(54) PRESSURE SENSOR ARRANGEMENT AND METHOD OF MANUFACTURING A PRESSURE SENSOR ARRANGEMENT

(71) Applicant: TDK Electronics AG, Muenchen (DE)

(72) Inventors: Markus Eberstein, Berlin (DE); Thomas Stendel, Rangsdorf (DE); Benjamin Bohl, Berlin (DE)

(21) Appl. No.: 18/839,674

(22) PCT Filed: Feb. 8, 2023
(86) PCT No.: PCT/EP2023/053077

§ 371 Date: Aug. 19, 2024

(30) Foreign Application Priority Data
Feb. 23, 2022 (DE) 10 2022 104 265.0

(51) Int. Cl. G01L 9/00; B23K 26/21

(52) U.S. Cl. CPC G01L 9/0042; B23K 26/21

(57) ABSTRACT

In an embodiment a pressure sensor arrangement includes a sensor element having a top side and a bottom side, wherein the sensor element comprises a membrane configured to be exposed to a medium and at least one detection element configured to measure a pressure of the medium, a substrate serving as a carrier of the sensor element, wherein the substrate comprises glass and a connection interface, produced by laser welding, arranged between the sensor element and the substrate, wherein the sensor element and the substrate are mechanically firmly and hermetically connected to one another at the connection interface.

### CROSS-REFERENCE TO RELATED APPLICATIONS

This patent application is a national phase filing under section 371 of PCT/EP2023/053077, filed Feb. 8, 2023, which claims the priority of German patent application 102022104265.0, filed Feb. 23, 2022, each of which is incorporated herein by reference in its entirety.

### TECHNICAL FIELD

The present invention relates to a pressure sensor arrangement. The invention further relates to a method of manufacturing a pressure sensor arrangement.

### BACKGROUND

Pressure sensors for differential, relative and absolute pressure are usually hybrid structures made of different functional materials with varying coefficients of thermal expansion and therefore each have an individually specific profile with regard to mechanical stresses between the materials used in the sensor when they are exposed to high temperatures (e.g. up to at least 150° C.) and low temperatures (e.g. down to at least −40° C.).

Known pressure sensor arrangements generally consist of a sensor element which is mechanically held and electrically contacted by a combination of different materials so that it can be installed in a working arrangement for pressure measurement. The mechanical mounting of the sensor element cannot be realized in aggressive media using organic adhesives, as organic adhesives are not always able to withstand the aggressive liquids. Therefore, the mechanical mounting of the sensor element in applications under aggressive conditions is realized by inorganic joining materials on metal or ceramic substrates, for example by hard or soft solder materials or joining glasses. In such setups, the coefficients of thermal expansion of the sensor element, solder material and substrate differ by a significant amount of up to 10 ppm/K and more.

The resulting mechanical stresses can lead to pressure measurement errors due to thermal hysteresis, pressure hysteresis, zero point stability, output stability under pressure and other errors that cannot be compensated for.

Therefore, state-of-the-art pressure sensor arrangements have technical limitations in terms of accuracy and functionality when exposed to high or low temperatures. The technical limitations of pressure sensor arrangements can therefore limit the functionality of complex technical systems in industrial and automotive applications.

### SUMMARY

Embodiments provide a pressure sensor arrangement and a manufacturing method which solve the problems prevalent in the prior art.

According to one embodiment, a pressure sensor arrangement is described. The pressure sensor arrangement is designed to determine differential, relative or absolute pressure. The pressure sensor arrangement is designed to reliably and accurately measure the pressure of a liquid or a gas under aggressive conditions. The pressure sensor arrangement is suitable for withstanding aggressive media, such as oil, fuel, urea, refrigerants and the like. The pressure sensor arrangement is further designed to operate in a wide temperature range, including low temperatures down to at least −40° C. and high temperatures up to at least 150° C. The pressure sensor arrangement is further designed to measure the pressure of a liquid or gas in a pressure range extending from 0.05 bar to 100 bar or more. The pressure sensor arrangement is suitable for use in a motor vehicle, for example as a vehicle exhaust application and/or in the powertrain. The pressure sensor arrangement is also suitable, for example, as a coolant or hydrogen pressure sensor for monitoring industrial processes.

The pressure sensor arrangement has at least one sensor element. The sensor element can be designed as a MEMS (micro-electro-mechanical system) component. Preferably, the sensor element comprises a silicon chip.

The sensor element has a membrane. The membrane is designed and arranged to be exposed to a medium, in particular a liquid or a gas. The sensor element has a top side and a bottom side. The top and bottom sides are arranged opposite each other. For the orientation of the sensor element, the side of the sensor element on which the membrane is located is in the following referred to as the top side of the sensor element and the opposite side as the bottom side of the sensor element. A media access point is located on the bottom side of the sensor element, which makes the membrane accessible to a pressurized medium from the bottom side.

The sensor element has at least one detection element, preferably a plurality of detection elements. The detection element is designed to measure a pressure of the medium. The detection element is formed on the membrane.

The pressure sensor arrangement also has a substrate. The substrate has a top side and a bottom side. The substrate serves as a carrier for the sensor element. The sensor element is arranged on the substrate, in particular on the top side of the substrate. The substrate is optically transparent. The substrate comprises glass. Preferably, the substrate is made of glass.

The sensor element and the substrate are mechanically firmly and inseparably connected to each other. The sensor element and the substrate are fused or welded together. A connection interface is formed between the sensor element and the substrate. The connection interface is an area in which the substrate and sensor element are connected to each other. The connection interface is formed between the bottom side of the sensor element and the top side of the substrate.

The connection interface is created by laser welding. In other words, the substrate and sensor element are joined together, in particular fused, by laser welding. Laser welding is preferably carried out with ultrashort laser pulses (pulse lengths in the picosecond range and shorter). The heat input generated by laser welding is limited locally, i.e. the substrate is not heated completely. Only in a joining area between the substrate and the sensor element, i.e. in an area in which the substrate and sensor element are joined together, does heating occur and thus the substrate and sensor element fuse. In particular, during laser welding with ultrashort laser pulses, the light is focused through the optically transparent substrate without heat input into it up to the joining area, where the heat leads to mechanically stable joining of the sensor element and substrate via multiphoton absorption in the focal area over a few tens of micrometers extremely locally via fusion and thus to the formation of the connection interface.

This means that the pressure sensor arrangement does not require any additional connecting means or additional joining material to connect the sensor element and substrate. The sensor element and the substrate are mechanically fixed and hermetically sealed to each other at the connection interface.

Joining the sensor element and substrate by laser welding eliminates the need for additional joining materials/joining agents, which can lead to mechanical stresses due to different expansion coefficients. This provides a particularly durable and reliable pressure sensor arrangement. Furthermore, the pressure sensor arrangement is more accurate and functional compared to conventional pressure sensor arrangements when exposed to high temperatures (up to at least 150° C.) and low temperatures (e.g. down to at least −40° C.).

According to one embodiment, the substrate has a coefficient of thermal expansion that differs from a coefficient of thermal expansion of the sensor element by less than 1 ppm/K. This means that the substrate and sensor element have an almost identical coefficient of thermal expansion. Due to the minimal or completely absent thermal expansion discrepancies, only minimal or no mechanical stresses arise in the pressure sensor arrangement that could be transferred from the substrate to the sensor chip at high temperatures and low temperatures. This provides a particularly reliable pressure sensor arrangement.

According to an embodiment, the sensor element has a connection base. The connection base is arranged between the sensor element and the substrate. The connection base is arranged at the bottom side of the sensor element. The sensor element and connection base form a sensor system.

The connection base ensures mechanical decoupling of the sensor element from the joining area with the substrate. The connection base is preferably used for very precise pressure sensors. The laser welding with ultrashort laser pulses described above is possible both with the sensor element and with a connection base located between the sensor element and the substrate.

The connection base comprises glass. Preferably, the connection base is made of glass. Preferably, the connection base has a material that is very similar or identical to the substrate material. In particular, a coefficient of thermal expansion of the connection base differs by less than 1 ppm/K from the coefficient of thermal expansion of the substrate. This means that the pressure sensor arrangement can be kept largely free of mechanical stresses.

According to one embodiment, the connection base is attached to the sensor element. For example, the connection base is connected to the sensor element by means of anodic bonding.

The connection interface is formed between the connection base and the substrate. In other words, the sensor system comprising the sensor element and the connection base is connected to the substrate by means of laser welding with ultrashort laser pulses. A laser energy for connecting the substrate and the sensor system is coupled for this purpose on a side of the substrate opposite the sensor system, i.e. on a bottom side of the substrate.

According to a further embodiment, a method for manufacturing a pressure sensor arrangement is described. Preferably, the method produces the pressure sensor arrangement described above. All features disclosed in relation to the pressure sensor arrangement or the method are also correspondingly disclosed in relation to the respective other embodiment and vice versa, even if the respective feature is not explicitly mentioned in the context of the respective embodiment. The method comprises the following steps:

A) Providing a substrate, preferably the substrate described above. The substrate comprises glass.

B) Providing a sensor element, preferably the sensor element described above. The sensor element preferably has a silicon chip. The sensor element has a top side and a bottom side. A membrane is formed on the top side of the sensor element. Preferably, the substrate has a coefficient of thermal expansion that differs from a coefficient of thermal expansion of the sensor element by less than 1 ppm/K.

C) Mechanically firm and hermetically sealed connection of substrate and sensor element by laser welding. Laser welding is carried out with ultrashort laser pulses. The pulse lengths are in the picosecond and/or femtosecond range. The substrate material is completely transparent to the laser wavelength. In this process, the light is focused through the optically transparent substrate without heat input up to a joining area between the substrate and the sensor element. At the joining area, the heat leads to a mechanically stable joining of the sensor element and substrate via non-linear absorption (multiphoton absorption) in the focal area over a few tens of micrometers extremely locally via fusion. The laser energy for joining the substrate and sensor element is coupled in on a side of the substrate opposite the sensor element (i.e. on a bottom side of the substrate). The energy is supplied without physical contact to the substrate/sensor element and can be selectively coupled into the desired joining area.

The laser welding connection also eliminates the need for additional joining agents to connect the substrate and sensor element. Due to the minimal or completely absent thermal expansion discrepancies, only minimal or no mechanical stresses arise in the pressure sensor arrangement, which are transferred from the substrate to the sensor chip at high temperatures and low temperatures. This provides a very flexible and efficient process that produces an extremely reliable, highly efficient and durable pressure sensor arrangement.

According to an embodiment, a connection base is provided in an optional step before the sensor element is connected to the substrate. The connection base comprises glass. Preferably, the substrate has a coefficient of thermal expansion that differs from a coefficient of thermal expansion of the sensor element and the connection base by less than 1 ppm/K. Preferably, the connection base and the substrate have the same material.

The connection base, in particular a top side of the connection base, is connected to the bottom side of the sensor element to form a sensor system comprising the connection base and the sensor element. Preferably, the connection base is connected to the sensor element by anodic bonding.

The sensor system is then joined to the substrate, in particular fused, using the laser welding process described above (laser welding with ultrashort laser pulses). In particular, laser welding is used to join a bottom side of the sensor system to the top side of the substrate in a mechanically strong and hermetically sealed manner. The laser energy for joining the substrate and sensor system is coupled in to a side of the substrate opposite the sensor system.

### BRIEF DESCRIPTION OF THE DRAWINGS

The drawing described below is not to be understood as true to scale. Rather, individual dimensions may be enlarged, reduced or even distorted for better representation.

FIG. 1 shows a sectional view of a pressure sensor arrangement according to an embodiment.

### DETAILED DESCRIPTION OF ILLUSTRATIVE EMBODIMENTS

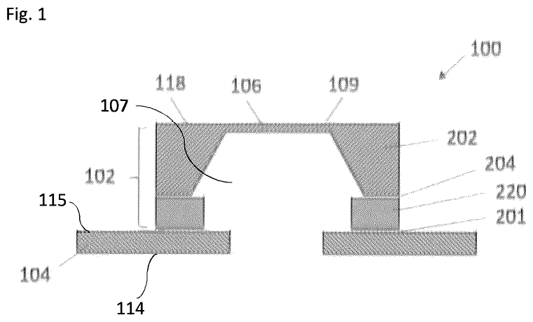

FIG. 1 shows a pressure sensor arrangement 100 for measuring absolute, relative or differential pressure. The pressure sensor arrangement 100 is suitable for use in a motor vehicle, for example as a vehicle exhaust application and/or in the powertrain. The pressure sensor arrangement 100 is also suitable, for example, as a coolant or hydrogen pressure sensor for monitoring industrial processes. The pressure sensor arrangement 100 can be used in a very wide temperature range (e.g. −40° C. to 150° C.).

The pressure sensor arrangement 100 has a sensor element 202 with a top side 118 and a bottom side 204. The sensor element 202 is preferably a silicon chip. The sensor element 202 has a membrane 106 on the top side 118, which delimits a cavity 107 in an inner region of the pressure sensor arrangement 100 towards the outside. The membrane 106 is designed and arranged to be exposed to a medium (e.g. a fluid or a gas). A detection element 109 is further arranged on the membrane 106 for measuring a pressure of the medium. Of course, the pressure sensor arrangement 100 can also have more than one detection element 109.

The pressure sensor arrangement 100 further comprises a substrate 104 as a carrier of the sensor element 202. The substrate 104 has a top side 115 and a bottom side 114. The sensor element 202 is arranged on or is attached to the top side 115 of the substrate 202. The sensor element 202 is welded or fused to the top side 115 of the substrate 202, as will be described in detail later.

The substrate 104 comprises glass. The substrate 104 has a coefficient of thermal expansion that differs from a coefficient of thermal expansion of the sensor element 202 by less than 1 ppm/K. Consequently, the substrate 104 and the sensor element 202 have approximately equal coefficients of thermal expansion, which leads to a reduction or avoidance of mechanical stresses, in particular at very high and at very low temperatures.

A connection interface 201 is formed between the sensor element 202 and the substrate 104. The connection interface 201 is an area in which the sensor element 202 and the substrate 104 are mechanically firmly and hermetically connected, in particular fused, to one another.

The connection interface 201 is created by laser welding with ultrashort laser pulses. In other words, substrate 104 and sensor element 202 are connected to each other by laser welding and thus without additional joining materials. This eliminates the need to introduce additional components to connect the sensor element 202 and the substrate 104. Mechanical stresses that occur due to the introduction of components with a coefficient of thermal expansion that differs greatly from that of the substrate 104/sensor element 202 are thus eliminated.

In the embodiment shown, the pressure sensor arrangement 100 additionally has a connection base 220. The connection base 220 is arranged between the sensor element 202 and the substrate 104 and comprises glass. A coefficient of thermal expansion of the connection base 220 differs by less than 1 ppm/K from the coefficient of thermal expansion of the substrate 104 and the sensor element 202. The occurrence of mechanical stresses due to the introduction of an element with a significantly different coefficient of thermal expansion compared to the coefficient of thermal expansion of the substrate 104/the sensor element 202 can thus be avoided.

The connection base 220 is attached to the sensor element 202. In particular, the connection base 220 and the sensor element 202 are firmly connected to one another, for example by means of anodic bonding. Sensor element 202 and connection base 220 together form a sensor system 102.

The connection interface 201 described above is formed between the sensor system 102, in particular a bottom side of the sensor system 102, and the substrate 104, in particular the top side 115 of the substrate 104. The sensor system 102 and the substrate 104 are thus mechanically firmly and hermetically sealed to each other at the connection interface 201, in particular fused together. The laser energy for generating the connection interface 201 is coupled in on a side of the substrate 104 opposite the sensor system 102, i.e. on the bottom side 114 of the substrate 104.

In an alternative embodiment (not explicitly shown), the connection base 220 can also be omitted. This means that in this case, the sensor element 202 is connected directly (without an intermediate element) to the substrate 104. In this case, the connection interface 201 is formed between the bottom side 204 of the sensor element 202 and the top side 115 of the substrate 104.

In the following, a method for manufacturing a pressure sensor arrangement, preferably the pressure sensor arrangement 100 described above, is described. All properties disclosed in relation to the pressure sensor arrangement 100 or the method are also disclosed accordingly in relation to the respective other embodiment and vice versa, even if the respective property is not explicitly mentioned in the context of the respective embodiment. The method comprises the following steps:

In a first step A), the substrate 104 is provided. The substrate 104 comprises glass as described above.

In a second step B), at least one sensor element 202, preferably a plurality of sensor elements 202, is provided. The sensor element 202 preferably comprises a silicon chip. The sensor element 202 has a top side 118 and a bottom side 204, wherein a membrane 106 is formed on the top side 118. As described above, the substrate 104 has a coefficient of thermal expansion that differs from a coefficient of thermal expansion of the sensor element 202 by less than 1 ppm/K.

In a next step C), the mechanically strong and hermetically sealed connection of substrate 104 and sensor element 202 is achieved by laser welding. The laser energy for joining the substrate 104 and the sensor element 202 is coupled in to a side of the substrate 104 opposite the sensor element 202 (i.e. the bottom side 114 of the substrate 104). The laser welding creates the connection interface 201, i.e. the area where the substrate 104 and the sensor element 202 are firmly connected to each other.

Laser welding is carried out with ultrashort laser pulses. The pulse lengths are in the picosecond and/or femtosecond range. The material of the substrate 104 is completely transparent to the laser wavelength. The light is focused through the substrate 104 without heat input into it up to a joining area between the substrate 104 and the sensor element 202. At this joining area, the heat leads via non-linear absorption (multiphoton absorption) in the focal area over a few tens of micrometers extremely locally via fusion to a mechanically stable joining of sensor element 202 and substrate 104, i.e. to the formation of the connection interface 201.

In an optional step, the connection base 220 is provided before step C). The connection base 220 comprises glass. A coefficient of thermal expansion of the connection base 220 differs from a coefficient of thermal expansion of the substrate 104 by less than 1 ppm/K. The connection base 220 is connected to the bottom side 204 of the sensor element, for example by anodic bonding, to form the sensor system 102.

Subsequently, in this embodiment, the sensor system 102 is connected to the substrate 104 by laser welding with ultrashort laser pulses as described above. In other words, the connection interface 201 is formed here between the sensor system 102 and the substrate 104. As described above, the welding can only be carried out via multiphoton absorption due to the special feature of the locally limited heat supply. The laser energy for connecting the substrate 104 and the sensor system 102 is coupled in to a side of the substrate 104 opposite the sensor system 102.

In a final step, the individual pressure sensor arrangements 100 are separated to make them available.

The description of the objects specified here is not limited to the individual special embodiments. Rather, the features of the individual embodiments can be combined with each other as desired-insofar as this makes technical sense.

1.-19. (canceled)

20. A pressure sensor arrangement comprising:
a sensor element having a top side and a bottom side, wherein the sensor element comprises a membrane configured to be exposed to a medium and at least one detection element configured to measure a pressure of the medium;
a substrate serving as a carrier of the sensor element, wherein the substrate comprises glass; and
a connection interface, produced by laser welding, arranged between the sensor element and the substrate,
wherein the sensor element and the substrate are mechanically firmly and hermetically connected to one another at the connection interface.

21. The pressure sensor arrangement according to claim 20, wherein the pressure sensor arrangement is free of a connecting means for connecting the sensor element and the substrate.

22. The pressure sensor arrangement according to claim 20, wherein the substrate has a coefficient of thermal expansion that differs from a coefficient of thermal expansion of the sensor element by less than 1 ppm/K.

23. The pressure sensor arrangement according to claim 20, wherein the sensor element comprises a silicon chip.

24. The pressure sensor arrangement according to claim 20, wherein the at least one detection element is arranged at the membrane.

25. The pressure sensor arrangement according to claim 20, wherein the medium is a liquid or a gas.

26. The pressure sensor arrangement according to claim 20, wherein a laser energy is coupled in to a bottom side of the substrate to create the connection interface and/or wherein laser welding is performed with ultrashort laser pulses.

27. The pressure sensor arrangement according to claim 20, further comprising a connection base disposed between the sensor element and the substrate, wherein the connection base comprises glass.

28. The pressure sensor arrangement according to claim 27, wherein the connection base is attached to the sensor element, and wherein the connection interface is arranged between the connection base and the substrate.

29. The pressure sensor arrangement according to claim 27, wherein the connection base is connected to the sensor element by an anodic bonding.

30. The pressure sensor arrangement according to claim 27, wherein the substrate has a coefficient of thermal expansion that differs from a coefficient of thermal expansion of the connection base by less than 1 ppm/K.

31. A method for manufacturing a pressure sensor arrangement, the method comprising:
providing a substrate comprising glass;
providing at least one sensor element, wherein the sensor element has a top side and a bottom side, and wherein a membrane is formed on the top side; and
forming a mechanically firm and hermetically sealed connection of the substrate and the sensor element by laser welding, wherein a connection interface is formed between the substrate and the sensor element while laser welding.

32. The method according to claim 31, wherein a laser energy for connecting the substrate and the sensor element is coupled in to a side of the substrate opposite the sensor element.

33. The method according to claim 31, wherein laser welding is carried out with ultrashort pulses.

34. The method according to claim 31, further comprising providing a connection base prior to forming the mechanically firm and hermetically sealed connection, wherein the connection base comprises glass, and wherein the connection base is connected to the bottom side of the sensor element to form a sensor system.

35. The method according to claim 34, wherein the connection base is connected to the sensor element by anodic bonding.

36. The method according to claim 34, wherein the sensor system is connected to the substrate by laser welding with ultrashort laser pulses.

37. The method according to claim 36, wherein a laser energy for connecting the substrate and the sensor system is coupled in to a side of the substrate opposite the sensor system.

38. The method according to claim 31, wherein the substrate has a coefficient of thermal expansion that differs from a coefficient of thermal expansion of the sensor element and/or a connection base by less than 1 ppm/K.
